(19) United States
(12) Patent Application Publication
(10) Pub. No.: US 2007/0088809 A1
(43) Pub. Date: Apr. 19, 2007

(54) Control system for controlling, accelerating and distributing of competence development

(75) Inventors: Anders Krantz, Gavle (SE); Rolf Bjallas, Jarfalla (SE)

Correspondence Address: NIXON & VANDERHYE, PC, 901 NORTH GLEBE ROAD, 11TH FLOOR, ARLINGTON, VA, 22203, US

(73) Assignee: Mapas Syd AB, Spanga (SE)

(21) Appl. No.: 11/250,638

(22) Filed: Oct. 17, 2005

(51) Int. Cl. G06F 15/173

(52) U.S. Cl. 709/223

(57) ABSTRACT

The present invention relates to a control system for controlling, accelerating and distributing of competence development. The system comprises at least one first memory device operable to store assessments and self-assessments for validation and education material. The control system also comprises a coach module operable to administrate course packages, learning pieces, assessments and study plans. The control system further comprises an individual module for each individual, wherein each individual module is operable to store individual-adapted course plans. The control system also comprises an individual validation module for each individual, wherein each individual validation module is operable to store results of the individual competence development. An archive module is operable to create and deliver statistics. The control system further comprises at least one control means operable to control who should have access to the content of the first memory device, the coach module, and the archive module.

### FIELD OF THE INVENTION

According to a first aspect the present invention relates to a control system for controlling, accelerating and distributing of competence development.

According to a second aspect the present invention relates to a method for controlling, accelerating and distributing of competence development.

According to a third aspect the present invention relates to at least one computer program product for controlling, accelerating and distributing of competence development.

### BACKGROUND OF THE INVENTION

Development in the teaching and learning educational field has progresssed very slowly. Pupils are still taught in traditional ways, to a very large extent.

Firstly, it is difficult to obtain an overall picture of existing educational processes and what they involve.

Secondly, there is at present no way of ensuring the quality of education/competence development. How shall the interface/interactivity and quality between pupils and teachers be ensured, regardless of whether the educational process/competence development takes place online or offline?

Document U.S. Pat. No. 5,267,865 describes a pedagogic instrument which creates the possibility of creating a given degree of interactivity between pupil and teacher on the basis of a defined teaching plan. The educational process or section of the course taken is aided and supported by sound and pictures, for example. This document deals solely with the teaching section in the absence of logic. On the other hand, the document fails to touch upon the full competence development process.

Document U.S. Pat. No. 6,157,808 describes a so-called Teacher's Platform, where the object has been to create different modules within the area of competence development with the intention of creating a communicative forum. There is no well-reasoned logic that supports the so-called competence development process, but that the functions, figuratively speaking, constitute a leaf diagram in which the individual leaves are described in the document as modules, in the absence of any coherent logic process.

The document U.S. Pat. No. 6,157,808 includes essentially a conceived content of so-called commercially established certificates. In principle, the function provides a possibility of creating a so-called gap analysis concerning the competence of an employee in relation to certificate requirements. This concerns primarily a so-called Human Resource tool which enables a company to keep track of the employee's competence.

The latest progress within this area can be described in the Publication No. US-2003-0002527-A1. This document relates to a control system for achieving quality ensured competence development. The control system is connected to a distributed computer network. The control system includes a first memory device which is connected to the distributed computer network and which is operable in storing all course sections for different courses and an ideal time for each course section. The control system also includes a second memory device which is connected to the distributed computer network and which is operable in storing all study material affiliated with said course sections. The control system also includes a third memory device which is connected to the distributed computer network and operable in storing individual-adapted course plans. The control system also includes a control device which is connected to the distributed computer network and which is operable in calculating and indicating a planned completion date for each individual's course plan, with the aid of said ideal time for different course sections and the time spent by the individual on different course sections. The control system also includes a fourth memory device which is connected to the distributed computer network and which is operable to store those course plans and course sections that have been completed by each respective individual.

### SUMMARY OF THE INVENTION

An object of the present invention is to solve the above-mentioned problems. Another object of the present invention is to further improve the latest developments within this area.

According to a first aspect of the preset invention there is provided a control system for controlling, accelerating and distributing of competence development. The control system is connected to a distributed computer network. The control system comprised at least one first memory device connected to said distributed computer network and operable to store assessments and self-assessments for validation and education material. The control system also comprises a coach module connected to said distributed computer network and operable to administrate course packages, learning pieces, assessments and study plans. The control system also comprises an individual module for each individual, wherein each individual module is connected to said distributed computer network and operable to store individual-adapted course plans. The control system also comprises an individual validation module for each individual, wherein each individual validation module is connected to said distributed computer network and operable to store the results of the individual competence development. The control system also comprises an archive module connected to said distributed computer network and operable to create and deliver statistics. The control system also comprises at least one control means connected to said distributed computer network and operable to control who should have access to the content of said first memory device, said coach module and said archive module.

This control system provides a technical aid for controlling, accelerating and distributing of competence development. Another advantage is that this control system is a technical aid for benchmarking and for taking advantage of others experiences within this area.

Another object of the present invention is to provide a method for controlling, accelerating and distributing of competence development, with the aid of a control system for controlling, accelerating and distributing of competence development. The method comprises the steps:
to choose from a first memory device and/or a coach module and/or an individual module, all comprised in said control system, education material, course packages, learning pieces and study plans;
to determine, with the aid of a control means comprised in said control system, if one has been granted access to said chosen education material, course packages, learning pieces and study plans;
to download statistics from an archive module comprised in said control system;
to download material from, depending on said downloaded statistics, said chosen accessible material;
to perform competence development with said downloaded material; and
in dependent of said downloaded material, to keep record of each content owners account with the aid of an administration module comprised in said control system.

This method provides an aid for controlling, accelerating and distributing of competence development. Another advantage is that this method provides an aid for benchmarking and for taking advantage of others experiences within this area.

Another object of the present invention is to provide at least one computer. The at least one computer program product, directly loadable into the internal memory of at least one digital computer program product comprises software code portions for performing the steps of the inventive method. The computer program product/products provides/provide an aid for controlling, accelerating and distributing of competence development. Another advantage is that the product/-products provides/provide an aid for benchmarking and for taking advantage of others experiences within this area.

It will be observed that the term “comprises/comprising” as used in this description is intended to denote the presence of a given characteristic, step or component, without excluding the presence of one or more other characteristic features, parts, steps, components or groups thereof.

### BRIEF DESCRIPTION OF THE DRAWINGS

Embodiments of the invention will now be described with reference to the accompanying drawings, in which

FIG. 1 is a block diagram of a control system for controlling, accelerating and distributing of competence development according to the present invention.

FIG. 2 is a flowchart illustrating a method for controlling, accelerating and distributing of competence development according to the present invention;

FIG. 3 is a more detailed version of the flowchart disclosed in FIG. 2;

FIG. 4 is a block diagram of a known control system for quality ensured competence development;

FIG. 5 is a flowchart illustrating a known method of achieving quality ensured competence development; and

FIG. 6 illustrates a schematically a number of computer program products according to the present invention.

### DETAILED DESCRIPTION OF EMBODIMENTS

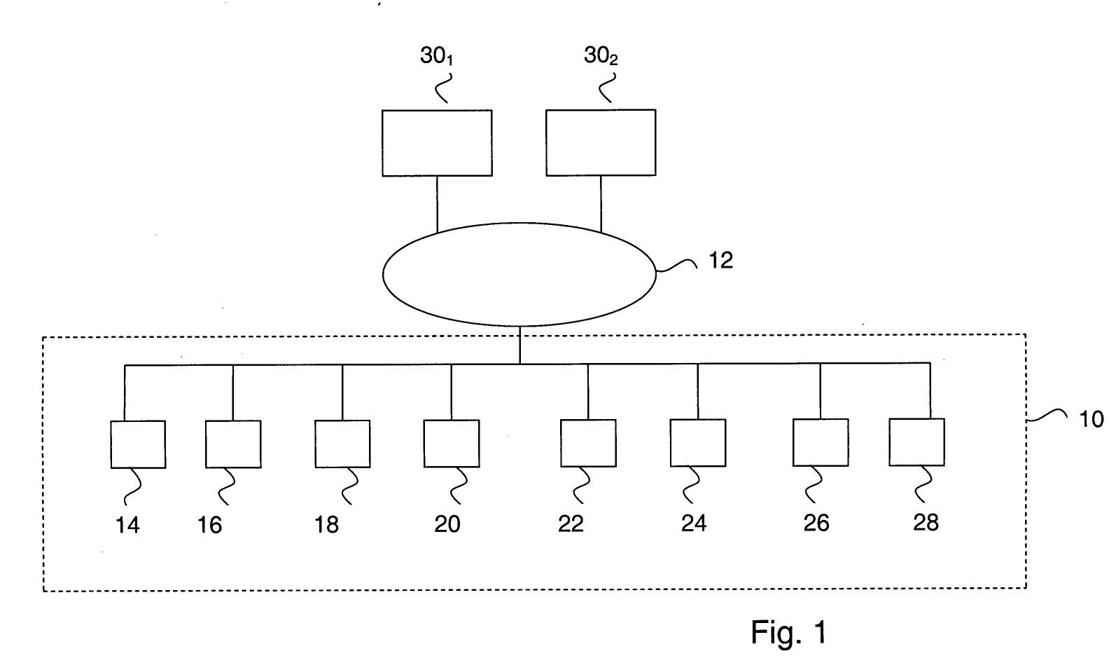

In FIG. 1 there is disclosed a block diagram of a control system 10 for controlling, accelerating and distributing of competence development according to the present invention. The control system 10 is connected to a distributed computer network 12. The distributed computer network 12 can e.g. be the Internet or a Wide Area Network (WAN). The control system 10 comprises at least one first memory device 14 connected to the distributed computer network 12. In order to simplify FIG. 1, there is only disclosed one first memory device 14. The first memory device 14 is operable to store assessments and self-assessments for validation and education material. The control system 10 also comprises a coach module 16 connected to the distributed computer network 12 and operable to administrate course packages, learning pieces, assessments and study plans. The control system 10 also comprises an individual module 18 for each individual, wherein each individual module 18 is connected to the distributed computer network 12 and operable to store individual-adapted course plans. In order to simplify FIG. 1, there is only disclosed one individual module 18. The control system 10 also comprises an individual validation module 20 for each individual, wherein each individual validation module 20 is connected to the distributed computer network 12 and operable to store the results of the individual competence development. In order to simplify FIG. 1, there is only disclosed one individual validation module 20. The control system 10 also comprises an archive module 22 connected to the distributed computer network 12 and operable to create and deliver statistics. The control system 10 also comprises at least one control means 24 connected to the distributed computer network 12 and operable to control who should have access to the content of said first memory device 14, said coach module 16 and said archive module 22. The control system 10 described so far corresponds to claim 1.

In a further embodiment, disclosed in FIG. 1, the control system 10 also comprises an administration module 26 connected to the distributed computer network 12 and operable to control each content owners copyright and to keep record of each content owners account. The control system 10 also comprises at least one recording means 28 connected to the distributed computer network 12 and operable to record the time spent for said course packages and learning pieces. In order to simplify FIG. 1, there is only disclosed one recording means 28.

According to a preferred embodiment of the control system 10, the archive module 22 is also operable to store evaluation of study results.

In FIG. 1 there is also disclosed two different computer devices 30₁, 30₂ by means of which it is possible to obtain access to the control system 10 by connecting to the distributed computer network 12.

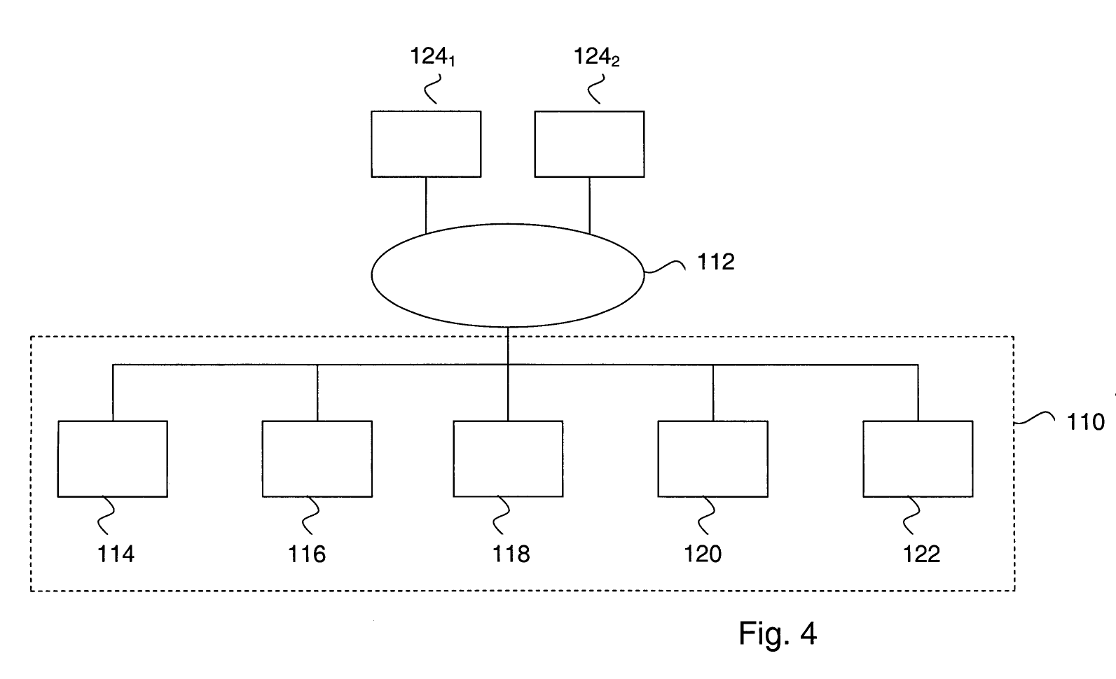

According to another preferred embodiment of the control system 10, it is connected to a second control system (see FIG. 4) for achieving quality ensured competence development via the distributed computer network 12.

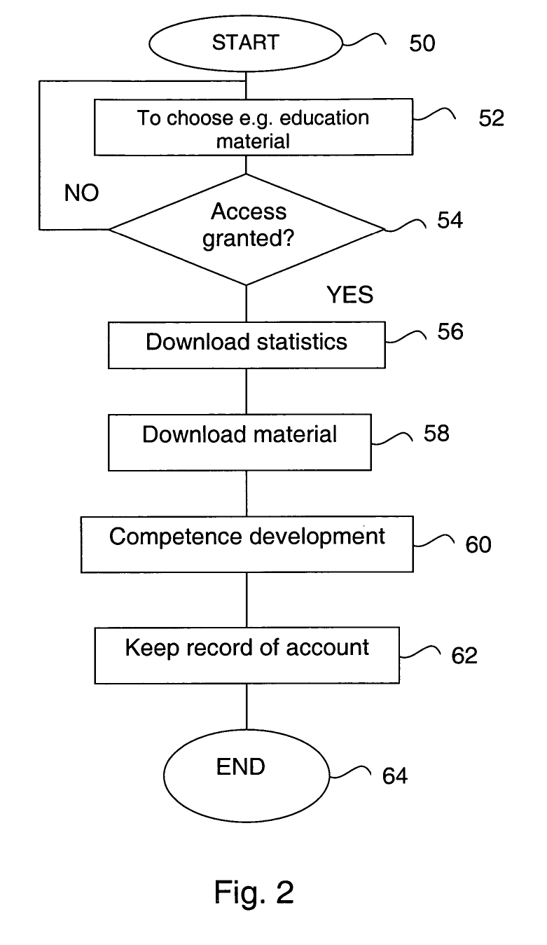

In FIG. 2 there is disclosed a flowchart of a method for controlling, accelerating and distributing of competence development according the present invention. The method is performed with the aid of a control system (see FIG. 1) for controlling, accelerating and distributing of competence development. The method begins at block 50. The method continues, at block 52, with the step: to choose from a first memory device and/or a coach module and/or an individual module, all comprised in the control system, education material, course packages, learning pieces and study plans. Thereafter, the method continues, at block 54, with the step: to determine, with the aid of a control means comprised in said control system, if one has been granted access to said chosen education material, course packages, learning pieces and study plans. If access has not been granted, the method performs the step according to block 52 again. If, on the other hand, access has been granted, the method continues, at block 56, with the step: to download statistics from an archive module comprised in the control system. The method then continues, at block 58, with the step: to download material from, depending on said downloaded statistics, the chosen accessible material. Thereafter, the method continues, at block 60, with the step: to perform competence development with said downloaded material. The method then continues, at block 62, with the step: in dependent of said downloaded material, to keep record of each content owners account with the aid of an administration module comprised in the control system. The method is terminated at block 64.

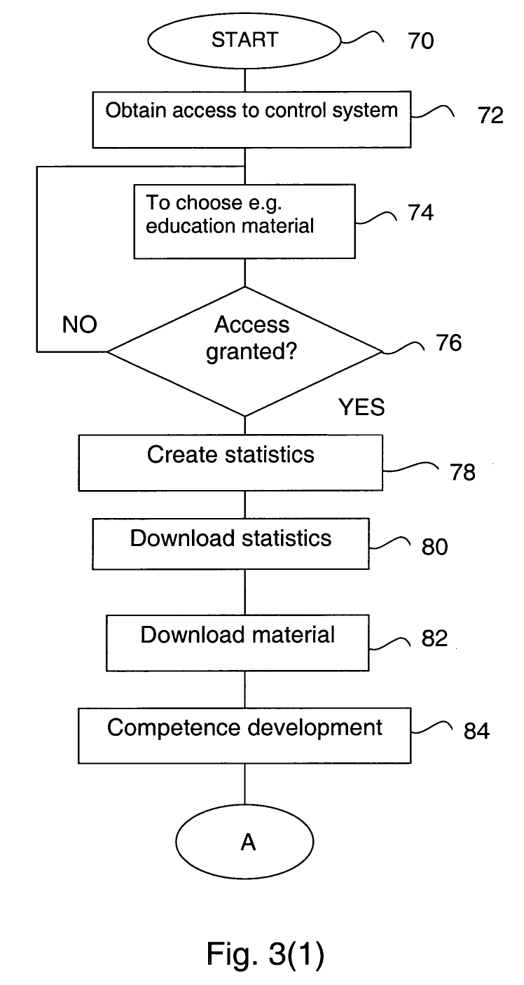

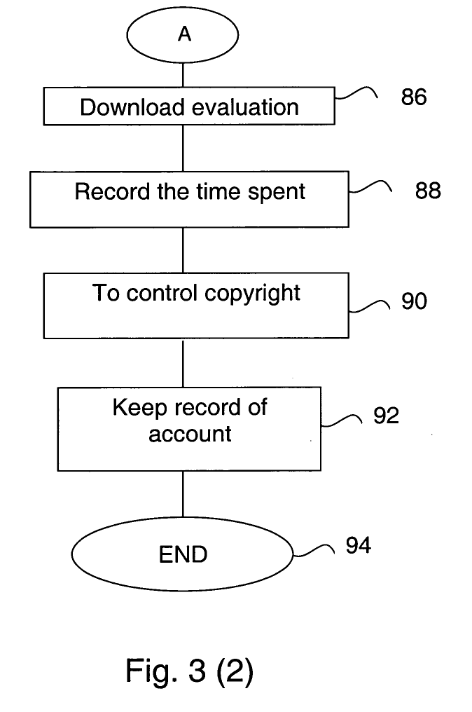

In FIG. 3 there is disclosed a more detailed version of the flowchart disclosed in FIG. 2, i.e., it illustrates a method for controlling, accelerating and distributing of competence development according to the present invention. The method is performed with the aid of a control system (see FIG. 1) for controlling, accelerating and distributing of competence development. The method begins at block 70. The method continues, at block 72, with the step: to obtain access to the control system by means of a computer device connectable to a distributed computer network. Thereafter, the method continues, at block 74, with the step: to choose from a first memory device and/or a coach module and/or an individual module, all comprised in the control system, education material, course packages, learning pieces and study plans. The method then continues, at block 76, with the step: to determine, with the aid of a control means comprised in the control system, if one has been granted access to said chosen education material, course packages, learning pieces and study plans. If access has not been granted, the method performs the step according to block 74 again. If, on the other hand, access has been granted, the method continues, at block 78, with the step: to is create statistics with the aid of an archive module comprised in the control system. The method then continues, at block 80, with the step: to download statistics from the archive module. Thereafter, the method continues, at block 82, with the step: to download material from, depending on said downloaded statistics, the chosen accessible material. The method then continues, at block 84, with the step: to perform competence development with the downloaded material. Thereafter, the method continues, at block 86, with the step: to download evaluation of study results from the archive module. The method then continues, at block 88, with the step: to record the time spent for said course packages and learning pieces with the aid of a recording means comprised in the control system. Thereafter, the method continues, at block 90, with the step: to control, with the aid of an administration module comprised in the control system, each content owners copyright. The method then continues, at block 92, with the step: in dependent of said downloaded material, to keep record of each content owners account with the aid of the administration module. The method is terminated at block 94.

In a preferred embodiment of said method, said distributed computer network is the Internet or a Wide Area Network (WAN).

In another preferred embodiment of said method, said control system is connected to a second control system for achieving quality ensured competence development. (See FIG. 4).

In FIG. 4, there is disclosed a block diagram of a known, second control system 110 for achieving quality ensured competence development. The control system 110 is connected to a distributed computer network 112, illustrated schematically in FIG. 4. The control system 110 includes at least one first memory device 114 connected to the distributed computer network 112. Only one first memory device 114 is shown in FIG. 4, for the sake of simplicity. The first memory device 114 is operable in storing all course sections of different courses and an ideal time for each course section. Thus, it is possible to gather from the first memory device 114 those course sections that are included in a specific course, and also an ideal time for completing each course. The control system 110 also includes at least one second memory device 116 connected to the distributed computer network 112. Only one second memory device 116 is shown in FIG. 4, for the sake of simplicity. The second memory device 116 is operable in storing all study material affiliated with said course section. Thus, a pupil can commence his/her studies with the aid of the second memory device 116. The control system 110 also includes at least one third memory device 118 connected to the distributed computer network 112. Only one third memory device 118 is shown in FIG. 4 for the sake of simplicity. The third memory device 118 is operable in storing individual-adapted course plans. The control system 110 also includes at least one control device 120 connected to the distributed computer network 112. For the sake of simplicity, only one such control device 120 is shown in FIG. 4. The control device 120 is operable in calculating and indicating the planned termination date for each individual course plan, with the aid of said ideal time regarding different course sections and the time spent by each individual on different course sections. The ideal time is obtained from the first memory device 114. The control system 110 also includes at least one fourth memory device 122 connected to the distributed computer network 112. Only one fourth memory device 122 is shown in FIG. 4, for the sake of simplicity. The fourth memory device 122 is operable in storing the course plans and course sections completed by each individual. Thus, each pupil has access to a pupil archive including all completed lessons. Also shown in FIG. 1 are two computer devices 124₁, 124₂, which can be connected to the distributed computer network 112. These computer devices 124₁, 124₂ provide access of an individual to the control system 110.

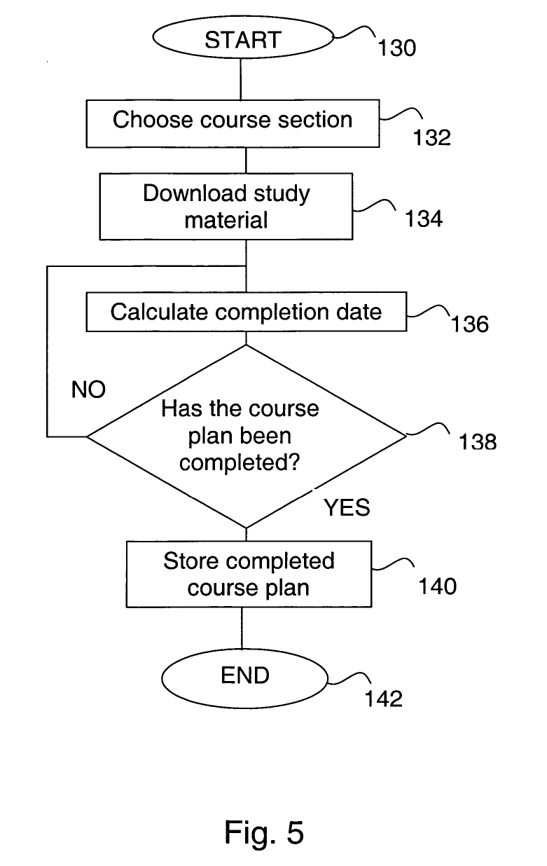

In FIG. 5, there is disclosed a known method of achieving quality ensured competence development.

The method starts at block 130. The method then continues at block 132 with the step of selecting a course section from a first memory device which is included in the second control system and which is operable to store all sections of different courses and also an ideal time taken to complete each course section, wherein the course sections chosen from an individual-adapted course plan which is stored in a third memory device in the second control system. The method then continues at block 134 with the step in which study material affiliated with the chosen course section from a second memory device included in the second control system and operable in storing all study material. The method is then continued at block 136 with the step of calculating and indicating a planned completion date for said course plan with the aid of control device included in the second system and with the aid of said ideal time for different course sections and the time spent by the individual for each course section. In block 138, there is asked the question as to whether one or more course sections or a course plan has/have been completed. if the response to this question is negative, the step according to block 136 is repeated. If the answer to the question is positive, the method continues at block 140 in which the completed course section and/or course sections is/are stored in a fourth memory device included in the second system. The method is terminated at block 142.

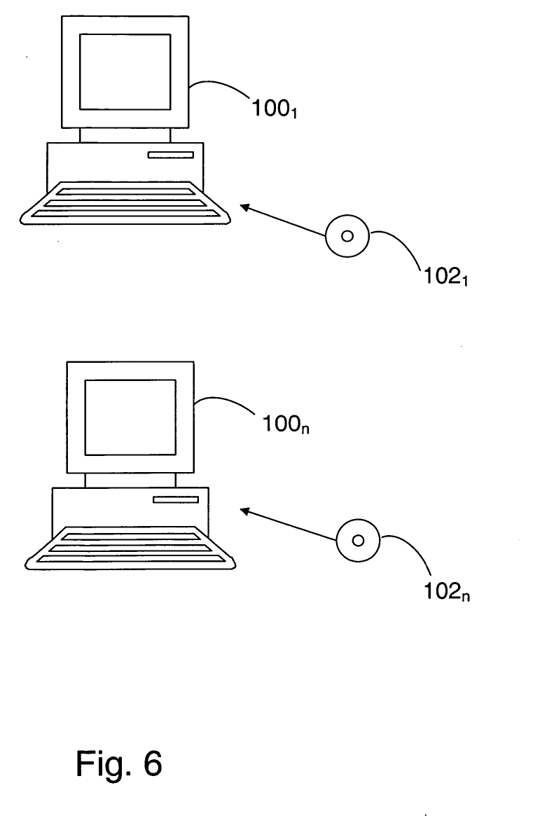

FIG. 6 is a schematic illustration of some computer program products according to the present invention. The illustration shows n number of different digital computers 100_{1, . . .} ,100ₙ, where n is an integer. The illustration also shows n number of computer program products 102 in the form of CD ROM disks. The different computer program products 102_{1, . . .} ,102ₙ can be downloaded directly into the internal memory of the n number of computers 100_{1, . . .} ,100ₙ. Each computer program product 102_{1, . . .} ,102ₙ includes program software parts for carrying out some or all of the steps according to FIG. 2, where the product/products 102_{1, . . .} ,102ₙ is/are run on said computer (computers) 100_{1, . . .} ,100ₙ. The computer program products may, for instance, have the form of diskettes, RAM disks, magnetic tapes, optomagnetic disks or some other suitable product form.

It will be understood that the invention is not restricted to the afore-described embodiments and that the person skilled in the art will be aware that many modifications are possible within the scope of the accompanying Claims.

1. A control system for controlling, accelerating and distributing of competence development, wherein said system is connected to a distributed computer network, wherein said system comprises at least one first memory device connected to said distributed computer network and operable to store assessments and self-assessments for validation and education material, a coach module connected to said distributed computer network and operable to administrate course packages, learning pieces, assessments and study plans, an individual module for each individual, wherein each individual module is connected to said distributed computer network and operable to store individual-adapted course plans, an individual validation module for each individual, wherein each individual validation module is connected to said distributed computer network and operable to store the results of the individual competence development, an archive module connected to said distributed computer network and operable to create and deliver statistics, and at least one control means connected to said distributed computer network and operable to control who should have access to the content of said first memory device, said coach module, and said archive module.

2. A control system for controlling, accelerating and distributing of competence development according to claim 1, characterized in that said control system also comprises an administration module connected to said distributed computer network, and operable to control each content owners copyright and to keep record of each content owners account.

3. A control system for controlling, accelerating, and distributing of competence development according to claim 2, characterized in that said archive module also is operable to store evaluation of study results.

4. A control system for controlling, accelerating, and distributing of competence development according to claim 3, characterized in that access to said control system is obtained by means of a computer device connectable to said distributed computer network.

5. A control system for controlling, accelerating, and distributing of competence development according to claim 4, characterized in that said distributed computer network is the Internet or a Wide Area Network (WAN).

6. A control system for controlling, accelerating, and distributing of competence development according to claim 5, characterized in that said control system also comprises at least one recording means operable to record the time spent for said course packages and learning pieces.

7. A control system for controlling, accelerating, and distributing of competence development according to claim 6, characterized in that said control system is connected to a second control system for achieving quality ensured competence development via said distributed computer network.

8. A method for controlling, accelerating and distributing of competence development with the aid of a control system for controlling, accelerating and distributing of competence development, wherein the method comprises the steps:
to choose from a first memory device and/or a coach module and/or an individual module, all comprised in said control system, education material, course packages, learning pieces and study plans;
to determine, with the aid of a control means comprised in said control system, if one has been granted access to said chosen education material, course packages, learning pieces and study plans;
to download statistics from an archive module comprised in said control system;
to download material from, depending on said downloaded statistics, said chosen accessible material;
to perform competence development with said downloaded material; and
in dependent of said downloaded material, to keep record of each content owners account with the aid of an administration module comprised in said control system.

9. A method for controlling, accelerating and distribution of competence development according to claim 8, characterized in that said method also comprises the step:
to create statistics with the aid of said archive module.

10. A method for controlling, accelerating and distributing of competence development according to claim 9, characterized in that said method also comprises the step:
to control, with the aid of said administration module, each content owners copyright.

11. A method for controlling, accelerating and distributing of competence development according to claim 10, characterized in that said method also comprises the step:
to download evaluation of study results from said archive module.

12. A method for controlling, accelerating and distributing of competence development according to claim 11, characterized in that said method also comprises the step:
to obtain access to said control system by means of a computer device connectable to said distributed computer network.

13. A method for controlling, accelerating and distributing of competence development according to claim 12, characterized in that said distributed computer network is the internet or a Wide Area Network (WAN).

14. A method for controlling, accelerating and distributing of competence development according to claim 13, characterized in that said method also comprises the step:
to record the time spent for said course packages and learning pieces with the aid of a recording means comprised in said control system.

15. A method for controlling, accelerating and distributing of competence development according to claim 14, characterized in that said control system is connected to a second control system for achieving quality ensured competence development.

16. At least one computer program product directly loadable into the internal memory of at least one digital computer, comprising software code portions for performing the steps of claim 8, when said at least one product is/are run on said at least one computer.
